(19) United States
(12) Patent Application Publication
(10) Pub. No.: US 2026/0048803 A1
(43) Pub. Date: Feb. 19, 2026

(54) MOTORCYCLE FAIRING AND MOTORCYCLE HAVING SAME

(71) Applicant: BOMBARDIER RECREATIONAL PRODUCTS INC., Valcourt (CA)

(72) Inventors: Arnaud VEILLET, Sherbrooke (CA); Renaud MARCOTTE, Sherbrooke (CA); Christian LABBE, Magog (CA)

(21) Appl. No.: 19/298,922

(22) Filed: Aug. 13, 2025

Related U.S. Application Data
(60) Provisional application No. 63/683,851, filed on Aug. 16, 2024.

(51) Int. Cl. B62J 17/00; B62K 25/06

(52) U.S. Cl. CPC B62J 17/00; B62K 25/06

(57) ABSTRACT

A motorcycle includes a frame, a motor connected to the frame, two wheels, a motorcycle and a fairing. The two wheels are rotationally connected to the frame, with at least one of the two wheels being operatively connected to the motor. The motorcycle component is connected to the frame, and is configurable between a first configuration and a second configuration. The fairing is connected to the frame, and includes first and second fairing portions. The first fairing portion at least partially covers the motorcycle component, and defines an opening providing access to at least part of the motorcycle component. The second fairing portion is selectively moveable between first and second positions. In the first position, the second fairing portion at least partially closes the opening. In the second position, the at least part of the motorcycle component is accessible via the opening.

### CROSS-REFERENCE TO RELATED APPLICATION

The present application claims priority to U.S. Provisional Patent Application No. 63/683,851, filed Aug. 16, 2024 entitled “Motorcycle Fairing and Motorcycle Having Same”, which is incorporated by reference herein in its entirety.

### FIELD OF TECHNOLOGY

The present technology relates to motorcycle fairings and motorcycles having fairings.

### BACKGROUND

Motorcycles are often equipped with fairings. These fairings can increase aerodynamic performance, can increase comfort, and can increase visual appeal of the motorcycle.

However, these fairings can restrict access to one or more motorcycle components, which may comprise adjustments to be performed by the user. This, in turn, can hinder maintenance or adjustment of such motorcycle components. Conventionally, fairings have to be fully removed from the motorcycle in order to access some components. Removing fairings can be tedious and time-consuming, depending on their size, shape, and connection mechanisms. Additionally, re-connecting fairings can also be difficult. Alternatively, the motorcycle may be designed without fairings or with lesser fairing coverage, however, any advantages conferred by the presence of fairings are thus lost or diminished.

There is therefore a desire for fairings which can enable easy access to components covered thereby.

### SUMMARY

It is an object of the present technology to ameliorate at least some of the inconveniences present in the prior art.

According to an aspect of the present technology, there is provided a motorcycle including a frame, a motor, two wheels, a motorcycle component, and a fairing. The motor is connected to the frame. The two wheels are rotationally connected to the frame, and at least one of the two wheels is operatively connected to the motor. The motorcycle component is connected to the frame, and is configurable between first and second configurations. The fairing is connected to the frame, and includes first and second fairing portions. The first fairing portion at least partially covers the motorcycle component, and defines an opening providing access to at least part of the motorcycle component. The second fairing portion is selectively moveable between first and second positions. In the first position, the second fairing portion at least partially closes the opening. In the second position, the at least part of the motorcycle component is accessible via the opening.

In some embodiments, at least a removable portion of the motorcycle component is removable through the opening.

In some embodiments, the removable portion of the motorcycle component is a fastener.

In some embodiments, the motorcycle component is at least one suspension assembly.

In some embodiments, the suspension assembly has an upper mount, and the at least part of the motorcycle component includes a fastener received through the upper mount. With the suspension assembly being in the first configuration, the fastener is received in the upper mount. With the suspension assembly being in the second configuration, the fastener is removed from the upper mount.

In some embodiments, the suspension assembly includes at least one adjuster. With the suspension assembly being in the first configuration, access to the at least one adjuster is restricted by the first fairing portion. With the suspension assembly being in the second configuration, the first fairing portion permits access to the at least one adjuster.

In some embodiments, the suspension assembly includes at least one adjuster. The at least one adjuster is accessible via the opening, and access to the at least one adjuster is restricted by the first fairing portion.

In some embodiments, the suspension assembly further includes a swingarm pivotally connected to the frame, and a lower mount opposite to the upper mount. The fastener is a first fastener, and the motorcycle further includes a second fastener connecting the lower mount to the swingarm.

In some embodiments, the motorcycle component is a saddlebag, in the first configuration, the saddlebag is connected to the frame, and in the second configuration, the saddlebag is disconnected from the frame.

In some embodiments, in the second position, the second fairing portion is spaced from the first fairing portion.

In some embodiments, the second fairing portion is threadedly engaged to the first fairing portion.

In some embodiments, the second fairing portion is a plug.

In some embodiments, the second fairing portion is pivotally connected to the first fairing portion.

In some embodiments, the second fairing portion is slidingly connected to the first fairing portion.

In some embodiments, with the second fairing portion being in the first position, the second fairing portion fully closes the opening.

According to another aspect of the present technology, there is provided a motorcycle fairing. The motorcycle fairing includes first and second fairing portions. The first fairing portion at least partially covers a motorcycle component that is configurable between a first configuration and a second configuration. The first fairing portion defines an opening providing access to at least part of the motorcycle component. The second fairing portion is selectively moveable between first and second positions. In the first position, the second fairing portion at least partially closes the opening. In the second position, the at least part of the motorcycle component is accessible via the opening.

In some embodiments, the opening is configured to receive at least a removable portion of the motorcycle component therethrough.

In some embodiments, in the second position, the second fairing portion is spaced from the first fairing portion.

In some embodiments, the second fairing portion is threadedly engaged to the first fairing portion.

In some embodiments, the second fairing portion is a plug.

In some embodiments, the second fairing portion is pivotally connected to the first fairing portion.

In some embodiments, the second fairing portion is slidingly connected to the first fairing portion.

In some embodiments, with the second fairing portion being in the first position, the second fairing portion fully closes the opening.

For the purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight-ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, left side of a motorcycle according to a non-limiting embodiment of the present technology, the motorcycle having a plurality of fairings, with one of the fairings having a fairing portion in a closed position;

FIG. 2 is the perspective view taken from the top, rear, left side of the motorcycle of FIG. 1, with the fairing portion being in an open position;

FIG. 3 is a left side elevation view of the motorcycle of FIG. 1, with a rear suspension assembly of the motorcycle being in an operating configuration;

FIG. 4 is a right side elevation view of the motorcycle of FIG. 1, with the rear suspension assembly of the motorcycle being in an adjusting configuration;

FIG. 5 is a right side elevation view of the motorcycle of FIG. 4, with the plurality of fairings being omitted;

FIG. 6 is a left side elevation view of a motorcycle according to an alternative non-limiting embodiment of the present technology;

FIG. 7 is a close-up schematic view of an alternative embodiment of one of the fairings of FIG. 1, with a fairing portion being pivotally connected to an other fairing portion; and

FIG. 8 is a close-up schematic view of an other alternative embodiment of one of the fairings of FIG. 1, with a fairing portion slidingly connected to an other fairing portion.

It should be noted that, unless otherwise explicitly specified herein, the drawings are not necessarily to scale.

### DETAILED DESCRIPTION

The present technology will be described herein with respect to a straddle-seat electric vehicle, specifically a two-wheeled electric motorcycle 100. However, it is contemplated that aspects of the present technology could be implemented in different straddle-seat vehicles, such as three-wheeled electric vehicles and/or two-wheeled motorcycles powered by internal combustion engines.

It is contemplated that the motorcycle 100 illustrated herein could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

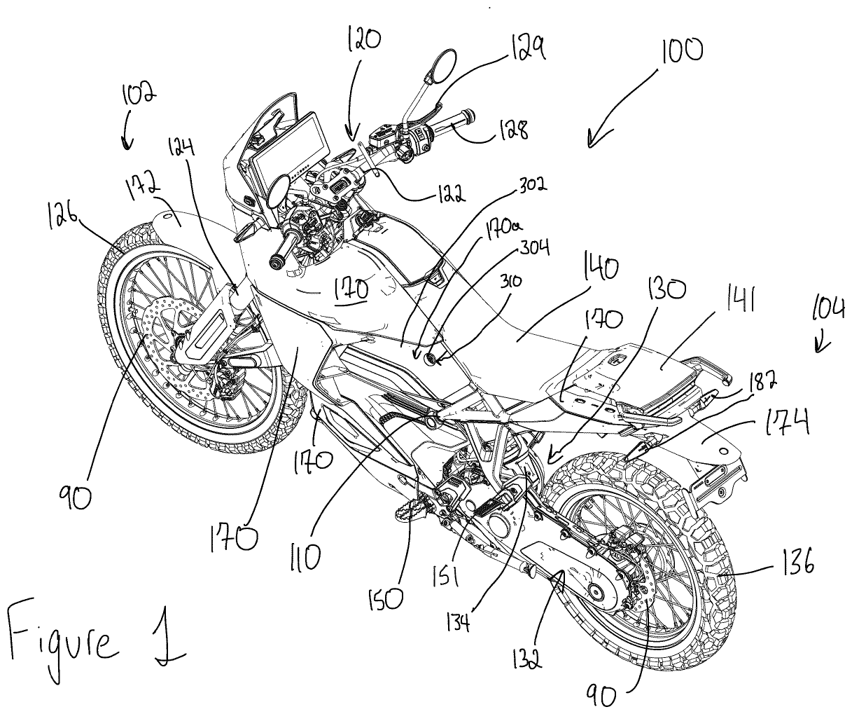

With reference to FIGS. 1 to 5, the electric motorcycle 100, referred to herein as the vehicle 100, has a front end 102 and a rear end 104 defined consistently with the forward travel direction of the vehicle 100.

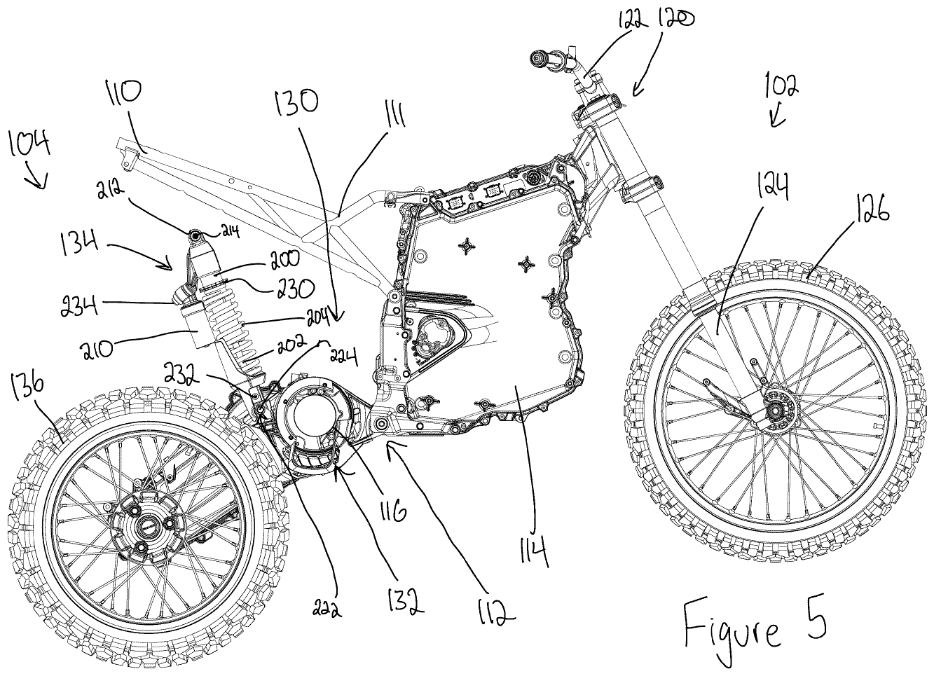

The vehicle 100 includes a frame 110. The vehicle 100 also includes a powerpack 112 for powering the vehicle 100. Shown in FIG. 5, the powerpack 112 includes a battery pack 114 that is supported by the frame 110 and a motor 116 that is electrically connected to the battery pack 114. It is contemplated that in other embodiments, the powerpack 112 could include an internal combustion engine and a fuel tank.

The vehicle 100 further includes a steering assembly 120 that is operatively connected to a front of the frame 110. The steering assembly 120 includes a handlebar assembly 122 and a front fork assembly 124 operatively connected to the handlebar assembly 122. A front wheel 126 is rotationally connected to a lower end of the front fork assembly 124. The steering assembly 120 can be used by the rider to turn the front wheel 126 to steer the vehicle 100.

A twist-grip throttle 128 is operatively connected on the right side of the handlebar assembly 122 for controlling vehicle speed. It is contemplated that the twist-grip throttle 128 could be replaced by a thumb throttle lever or some other type of throttle input device. The twist-grip throttle 128 could be disposed on the left side of the handlebar assembly 122 in some embodiments. The handlebar assembly 122 also includes a brake lever 129 on a right side for activating brake assemblies 90.

The vehicle 100 further includes a rear suspension assembly 130. The rear suspension assembly 130, which includes a swingarm 132 and a shock absorber 134, will be described in greater detail below.

A rear wheel 136 is rotationally connected to the swingarm 132. The rear wheel 136 is drivingly connected to the motor 116 via a driving assembly 117 that is disposed on the swingarm 132.

With continued reference to FIGS. 1 to 5, the vehicle 100 includes a straddle seat 140 disposed longitudinally between the front and rear wheels 126, 136. The straddle seat 140 is connected to frame 110. Specifically, the frame 110 has a seat portion 111 (FIG. 5) upon which the straddle seat 140 is disposed. In the illustrated implementation, the straddle seat 140 is intended to accommodate a single adult-sized rider (i.e. the driver). A passenger seat portion 141, which is for accommodating a passenger behind the driver, is also disposed on the seat portion 111. It is contemplated that that the straddle seat 140 could be longer and/or that the passenger seat portion 141 could be omitted. It is contemplated that the straddle seat 140 may be supported differently in other embodiments.

A driver footrest 150 is disposed on either side of the vehicle 100. The driver footrests 150 are positioned vertically lower than the straddle seat 140 to support the driver's feet. It is contemplated that the footrests 150 could be implemented in various forms other than those illustrated, including but not limited to pegs and footboards. The vehicle 100 is also provided with passenger footrests 151 disposed rearward of the driver footrest 150 on each side of the vehicle 100, for supporting a passenger's feet. It is contemplated that the passenger footrests 151 may be omitted in some embodiments.

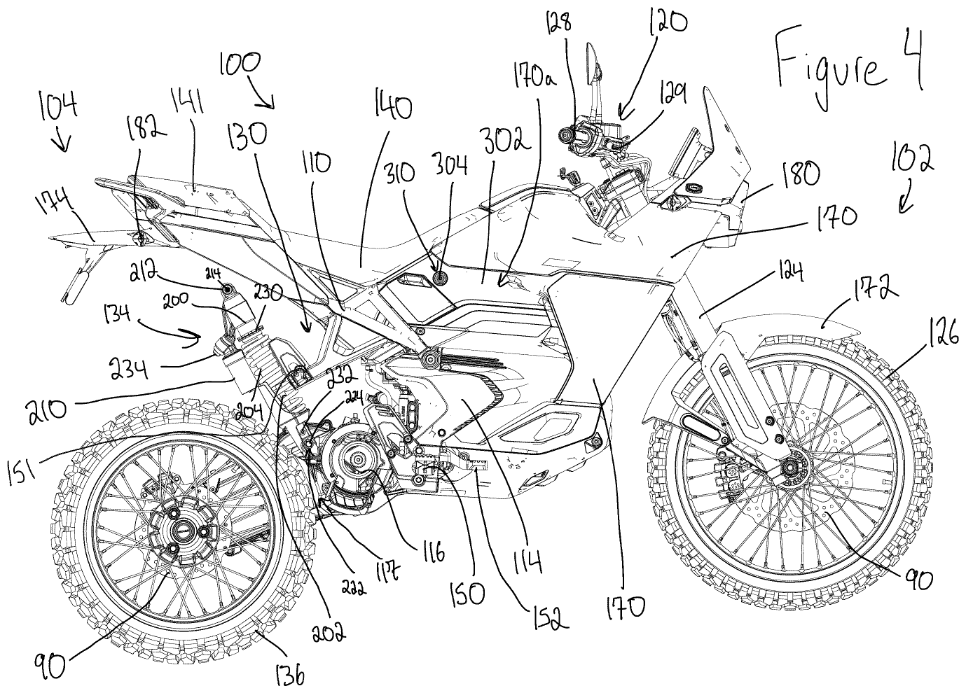

As seen in FIG. 4, a brake pedal 152 is next to the right driver footrest 150 for braking the vehicle 100. The brake pedal 152 is disposed forward of the right driver footrest 150 such that the driver can actuate the brake pedal 152 with a front portion of the right foot while a rear portion of the right foot remains on the right driver footrest 150.

Each of the front wheel 126 and the rear wheel 136 is provided with a brake assembly 90. The brake assemblies 90 of the wheels 126, 136, along with the brake lever 129 and the brake pedal 152, form part of a brake system. Each brake assembly 90 is a disc-type brake mounted onto the spindle of the respective wheel 126 or 136. Other types of brakes are contemplated. The brake pedal 152, as well as the brake lever 129, are operatively connected to the brake assemblies 90 provided on each of the front wheel 126 and the rear wheel 136. The brake system further includes a regenerative braking system (not shown) that uses the electric motor 116 as a generator to charge the battery pack 114 while slowing the vehicle 100.

The vehicle 100 further includes a plurality of fairings 170 that generally form the body of the vehicle 100. The fairings 170 may be referred to as body panels. The fairings 170 are connected to the frame 110 and the battery pack 114. The fairings 170 may be additionally and/or alternatively connected to another component of the vehicle 100 such as a bracket or the rear suspension assembly 130. The fairings 170 at least partially enclose and/or cover and/or protect some internal components of the vehicle 100 such as the powerpack 112 and the rear suspension assembly 130. In some instances, the fairings 170 can increase aerodynamic performance of the vehicle 100, which can positively impact an efficiency of the vehicle 100, and can improve ride quality of the vehicle 100. Some of the fairings 170 will be described in greater detail below.

The vehicle 100 also includes a front fender 172 disposed at the front of the vehicle 100 and extending partially over the front wheel 126. Rearward of the straddle seat 140, the vehicle 100 also has rear fender panel 174 extending at least partially over the rear wheel 136 and configured to support a vehicle license plate.

The vehicle 100 includes a front headlight 180 attached to the front fork assembly 124 and electrically connected to the battery pack 114. The vehicle 100 also has rear braking and indicator lights 182 supported by the rear fender panel 174 and electrically connected to the battery pack 114.

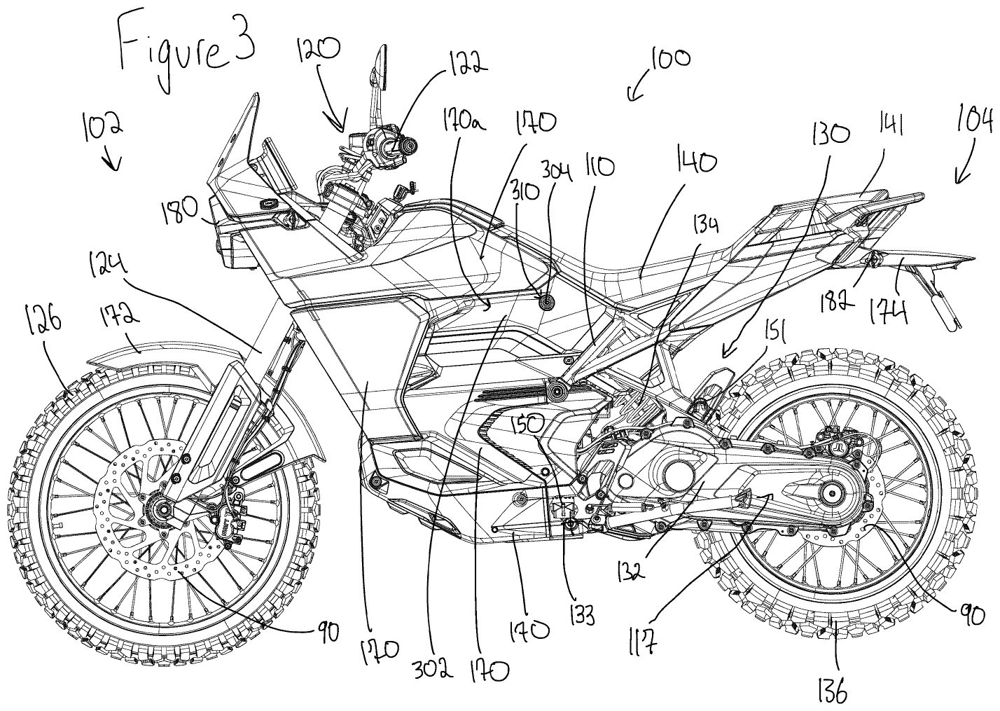

Referring to FIGS. 3 to 5, the rear suspension assembly 130 will now be described in greater detail. As mentioned above, the rear suspension assembly 130 includes the swingarm 132 and the shock absorber 134.

The swingarm 132 is pivotally connected to the frame 110 about a pivot axis 133 (FIG. 3) that extends generally laterally. As best seen in FIG. 4, the motor 116 is supported by the swingarm 132. It is contemplated that the motor 116 may be disposed elsewhere in other embodiments.

The shock absorber 134 is a piggy-back shock absorber. It is contemplated that in other embodiments, the shock absorber 134 could be another type of shock absorber, like a remote reservoir shock absorber.

The shock absorber 134 has a piston chamber 200 containing a damping fluid, a piston rod 202 and a coil spring 204.

The piston chamber 200 is fluidly connected to an external reservoir 210. The external reservoir 210 is mounted to the piston chamber 200. It is contemplated that in some embodiments, the external reservoir 210 may be a remote reservoir (i.e., the external reservoir could be spaced from the piston chamber 200 and fluidly connected thereto by a conduit). In yet other embodiments, the external reservoir 210 may be omitted.

The piston chamber 200 has an upper mount 212 configured to connect the piston chamber 200, and thus the shock absorber 134, to the frame 110. More specifically, the upper mount 212 receives a fastener 214 that fastens the upper mount 212 to the frame 110 vertically lower than the straddle seat 140. In the present embodiment, the fastener 214 is a threaded bolt. The treaded bolt may have a head that is easy to manually grasp (so that the fastener 214 may be fastened and unfastened without needing any tools). It is contemplated that in some embodiments, the fastener 214 could be a pin or a peg. As will be described below, the fastener 214 may be referred to as a removable portion of the shock absorber 134.

The piston rod 202 is movably received in the piston chamber 200. The piston rod 202 has a lower mount 222 configured to connect the piston rod 202, and thus the shock absorber 134, to the swingarm 132. More specifically, the lower mount 222 receives a fastener 224 that fastens the lower mount 222 to the swingarm 132. As will be described below, the fastener 224 may be referred to as a removable portion of the shock absorber 134. In the present embodiment, the fastener 224 is a threaded bolt. The treaded bolt may have a head that is easy to manually grasp (so that the fastener 224 may be fastened and unfastened without needing any tools). It is contemplated that in some embodiments, the fastener 224 could be a pin or a peg.

The coil spring 204 winds around part of the piston chamber 200 and around part of the piston rod 202. More specifically, one end of the coil spring 204 is connected to the piston rod 202, and an other end of the coil spring 204 is connected to the piston chamber 200 via a ring 230. As will be described below, the ring 230 is moveable along the piston rod 202 for modulating a preload on the coil spring 204.

The shock absorber 134 has adjusters that can be selectively adjusted for modulating a suspension response of the shock absorber 134 (e.g., increasing or decreasing damping). Thus, adjusting the adjusters can modulate the suspension response of the rear suspension assembly 130. More specifically, the shock absorber 134 has the ring 230, a rebound damping adjuster 232 and a compression damping adjuster 234. The ring 230, as mentioned above, is disposed on the piston chamber 200. The rebound damping adjuster 232 is disposed at the bottom of the shock absorber 134. The compression damping adjuster 234 is disposed on the external reservoir 210.

In order to permit adjustment of the rear suspension characteristics, the rear suspension assembly 130 is configurable between an operating configuration and an adjusting configuration.

As shown in FIGS. 1 to 3, when the rear suspension assembly 130 is in the operating configuration, the shock absorber 134 is connected to the frame 110 and to the swingarm 132 in permit operation of the vehicle 100. More specifically, the fastener 214 is received in the upper mount 212 and in the frame 110, and the fastener 224 is received in the lower mount 222 and in the swingarm 132. When the rear suspension assembly 130 is in the operating configuration, the pivotal movement of the swingarm 132 about the pivot axis 133 with respect to the frame 110 is limited and damped by the shock absorber 134. In the operating configuration, access to the ring 230, access to the rebound damping adjuster 232 and access to the compression damping adjuster 234 are restricted by some of the fairings 170.

Referring to FIGS. 4 and 5, when the rear suspension assembly 130 is in the adjusting configuration, the shock absorber 134 is disconnected from the frame 110, but is connected to the swingarm 132. Thus, the fastener 214 is out of the upper mount 212 and out of the frame 110. However, the fastener 224 remains received in the lower mount 222 and in the swingarm 132. In the adjusting configuration, due to the shock absorber 134 being disconnected from the frame 110, a range of motion of the pivotal movement of the swingarm 132 about the pivot axis 133 with respect to the frame 110 is increased, such that as a result, the rear suspension assembly 130 is moveable to a position where access to the ring 230, access to the rebound damping adjuster 232 and access to the compression damping adjuster 234 are provided to permit adjustment of the shock absorber characteristics.

When the rear suspension assembly 130 is in the adjusting configuration, the shock absorber 134 can easily be disconnected from the swingarm 132 by removing the fastener 224 from the lower mount 222 and from the swingarm 132. This may be done to replace part, such as the coil spring 204, or all of the shock absorber 134 in order to modulate a suspension response provided by the rear suspension assembly 130.

Referring to FIGS. 1 to 4, two of the fairings 170, namely fairings 170a, will be described in greater detail. It will be appreciated that features and/or configuration of the fairings 170a may be present in one or more of the other fairings 170.

One of the fairings 170a is disposed on one lateral side of the vehicle 100, and the other fairing 170a is disposed on the other lateral side of the vehicle 100. The fairings 170a are mirror images of one another, and therefore, only one fairing 170a will be described herewith.

The fairing 170a is positioned, in part, vertically lower than the straddle seat 140. The fairing 170a includes a fairing portion 302 and a fairing portion 304.

The fairing portion 302 extends in the longitudinal and lateral directions, and is generally shaped to engage against thighs of the driver of the vehicle 100. It is understood that the fairing portion 302 may be shaped differently.

The fairing portion 302 is positioned to cover part of the rear suspension assembly 130. As will be described below, it is contemplated that the fairing portion 302 could be configured to at least partially cover another component of the vehicle 100. In the illustrated embodiment, the fairing portion 302 partially covers the shock absorber 134. Specifically, the fairing portion 302 extends around an upper portion of the shock absorber 134, including around part of the upper mount 212. It is contemplated that in some embodiments, the fairing portion 302 could be configured to entirely cover the shock absorber 134.

The fairing portion 302 defines an opening 310. The fairing portion 302 and the opening 310 are configured such that the opening 310 is generally aligned with part of the rear suspension assembly 130 and provides access thereto. More specifically, the opening 310 provides access to the upper mount 212 and the fastener 214. Thus, the opening 310 provides access to an internal component of the vehicle 100 that may be spaced from the fairing portion 302, and that is generally meant to remain at least partially covered during use. The opening 310 is sized and shaped such that the fastener 214 may be received therethrough, such that the fastener 214 may be considered as being a removable portion of the rear suspension assembly 130. It is contemplated that in some embodiments, the opening 310 could be shaped to limit how much the fastener 214 may be removed. For example, the opening 310 may be tapered so as to stop the movement of the fastener 214 away from the upper mount 212 once the fastener 214 is out of the upper mount 212. In the present embodiment, the opening 310 is a threaded opening. As will be described below, it is contemplated that the opening 310 may not be threaded.

It is contemplated that in some embodiments, the opening 310 may provide access to one or more of the ring 230, the rebound damping adjuster 232 and the compression damping adjuster 234, such that the rear suspension assembly 130 may be, at least in part, adjusted via the opening 310.

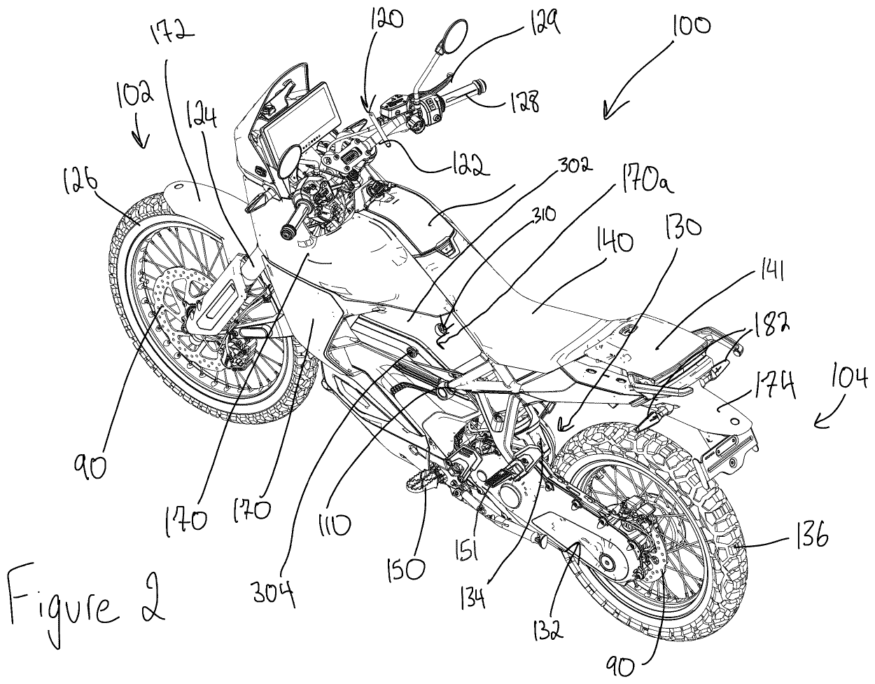

The fairing portion 304 is a plug that is selectively threadedly engaged with the threaded opening 310. The fairing portion 304 is moveable, with respect to the fairing portion 302, between a closed position (FIG. 1) and an open position (FIG. 2).

In the closed position, the fairing portion 304 fully closes the opening 310. It is contemplated than in some embodiments, while in the closed position, the fairing portion 304 could only partially close the opening 310.

In the open position, the fairing portion 304 is removed and spaced from the fairing portion 302, such that the opening 310 is open, and therefore access to the fastener 314 via the opening 310 is provided. It is contemplated that in some embodiments, the fairing portion 304 could be connected to the fairing portion 302 by a tether.

In the present embodiment, the fairing portion 304 is a quarter-turn plug, such that the fairing portion 304 can be moved between the open and closed positions by a quarter rotation. It is contemplated that the connection between the fairing portions 302, 304 may vary from one embodiment to another.

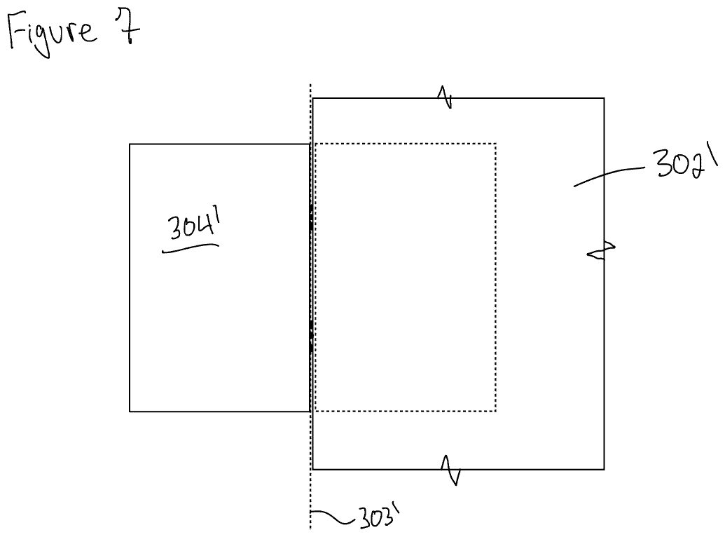

For example, referring to FIG. 7, in an alternative embodiment, the fairing portion 304′ is pivotally connected to the fairing portion 302′ about a pivot axis 303′. The fairing portion 304′ is moveable relative to the fairing portion 302′ between an open position (solid line) and a closed position (dotted line).

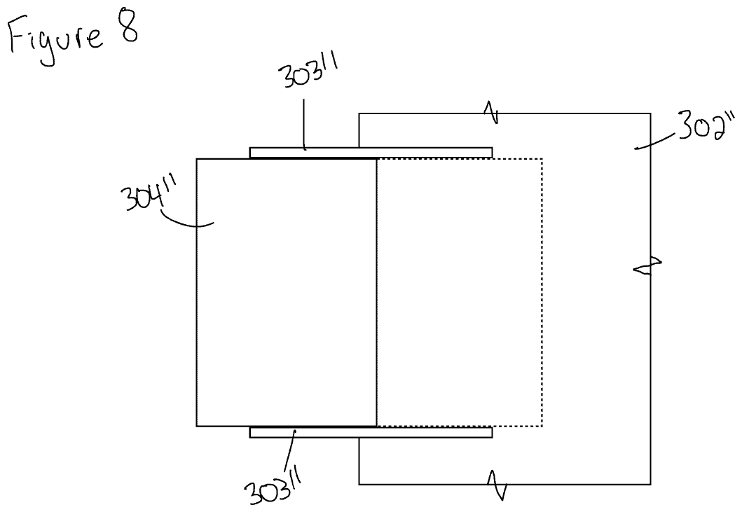

In another example, referring to FIG. 8, the fairing portion 304″ is slidingly connected to the fairing portion 302″ via rails 303″. Additionally, the fairing portion 304″ is moveable relative to the fairing portion 302″ between an open position (solid line) and a closed position (dotted line).

Referring back to FIGS. 1 to 4, a description of the fairing 170a enabling access to a component of the vehicle 100 without having to remove the whole fairing 170a will now be provided. In the present embodiment, the component to be accessed is the rear suspension assembly 130, but it is contemplated that it could be another component.

During normal riding conditions, the rear suspension assembly 130 is in the operating configuration, and the fairing 170a covers part of the rear suspension assembly 130, such that the ring 230, the rebound damping adjuster 232 and the compression damping adjuster 234 cannot be accessed.

In some embodiments, if there is a desire to access the rear suspension assembly 130, for example to modulate the suspension response thereof, the opening 310 may be configured to provide access to one or more of the ring 230, the rebound damping adjuster 232 and the compression damping adjuster 234, such that the rear suspension assembly 130 may be adjusted via the opening 310, after moving the fairing portion 304 to the open position.

If there is a desire to access the rear suspension assembly 130, for example to modulate the suspension response thereof, the rear suspension assembly 130 may need to be moved the adjusting configuration. Thus, the fairing portion 304 is moved from the closed position to the open position, which provides access to the fastener 214 via the opening 310. The fastener 214 can then be disconnected from the upper mount 212 and the frame 110, resulting in the rear suspension assembly 130 being in the adjusting configuration. At this point, the rear suspension assembly 130 can be moved to access the ring 230, the rebound damping adjuster 232 and/or the compression damping adjuster 234.

When the adjustment has been done, the rear suspension assembly 130 can be moved so that the upper mount 212 is generally aligned with the opening 310, which enables the fastener 214 to easily reconnect with the upper mount 212 and the frame 110.

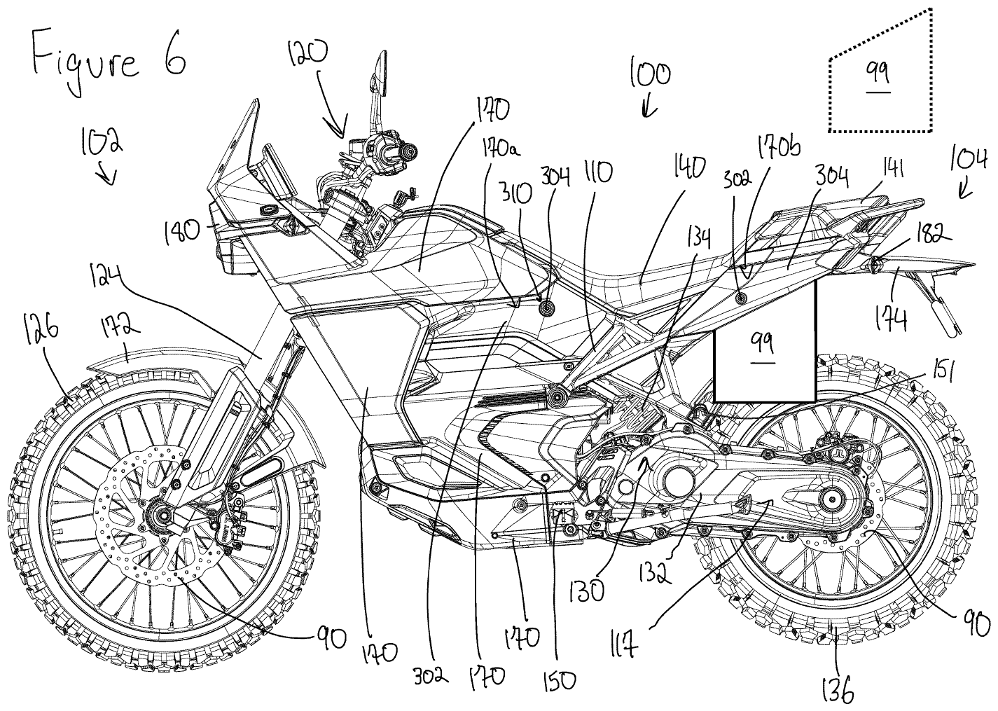

In the present embodiment, the fairing 170a is described as covering the rear suspension assembly 130. However, it is contemplated that another fairing 170 could cover another component. For example, in FIG. 6, a fairing 170b covers an upper portion of a saddlebag 99 (shown schematically). The saddlebag 99 is configurable between a connected configuration (solid line) and a disconnected configuration (dotted lines).

The fairing 170b has the fairing portions 302, 304 that enable, similarly to the fairing 170a, to selectively connect or disconnect the saddlebag 99.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A motorcycle comprising:
a frame;
a motor connected to the frame;
two wheels rotationally connected to the frame, at least one of the two wheels being operatively connected to the motor;
a motorcycle component connected to the frame, the motorcycle component being configurable between a first configuration and a second configuration; and
a fairing connected to the frame, the fairing including:
a first fairing portion at least partially covering the motorcycle component, the first fairing portion defining an opening providing access to at least part of the motorcycle component; and
a second fairing portion selectively moveable between:
a first position, in which the second fairing portion at least partially closes the opening; and
a second position, in which the at least part of the motorcycle component is accessible via the opening.

2. The motorcycle of claim 1, wherein at least a removable portion of the motorcycle component is removable through the opening.

3. The motorcycle of claim 1, wherein the removable portion of the motorcycle component is a fastener.

4. The motorcycle of claim 1, wherein the motorcycle component is at least one suspension assembly.

5. The motorcycle of claim 4, wherein:
the suspension assembly has an upper mount;
the at least part of the motorcycle component includes a fastener received through the upper mount;
with the suspension assembly being in the first configuration, the fastener is received in the upper mount; and
with the suspension assembly being in the second configuration, the fastener is removed from the upper mount.

6. The motorcycle of claim 5, wherein:
the suspension assembly includes at least one adjuster, and
with the suspension assembly being in the first configuration, access to the at least one adjuster is restricted by the first fairing portion; and
with the suspension assembly being in the second configuration, the first fairing portion permits access to the at least one adjuster.

7. The motorcycle of claim 4, wherein the suspension assembly includes at least one adjuster, the at least one adjuster is accessible via the opening, and access to the at least one adjuster is selectively restricted by the first fairing portion.

8. The motorcycle of claim 6, wherein:
the suspension assembly further includes:
a swingarm pivotally connected to the frame; and
a lower mount opposite to the upper mount; and
the fastener is a first fastener, and the motorcycle further includes a second fastener connecting the lower mount to the swingarm.

9. The motorcycle of claim 1, wherein in the second position, the second fairing portion is spaced from the first fairing portion.

10. The motorcycle of claim 1, wherein the second fairing portion is threadedly engaged to the first fairing portion.

11. The motorcycle of claim 10, wherein the second fairing portion is a plug.

12. The motorcycle of claim 1, wherein the second fairing portion is pivotally connected to the first fairing portion.

13. The motorcycle of claim 1, wherein the second fairing portion is slidingly connected to the first fairing portion.

14. A motorcycle fairing comprising:
a first fairing portion at least partially covering a motorcycle component configurable between a first configuration and a second configuration, the first fairing portion defining an opening providing access to at least part of the motorcycle component; and
a second fairing portion selectively moveable between:
a first position, in which the second fairing portion at least partially closes the opening; and
a second position, in which the at least part of the motorcycle component is accessible via the opening.

15. The motorcycle fairing of claim 14, wherein the opening is configured to receive at least a removable portion of the motorcycle component therethrough.

16. The motorcycle fairing of claim 14, wherein in the second position, the second fairing portion is spaced from the first fairing portion.

17. The motorcycle fairing of claim 15, wherein the second fairing portion is threadedly engaged to the first fairing portion.

18. The motorcycle fairing of claim 17, wherein the second fairing portion is a plug.

19. The motorcycle fairing of claim 14, wherein the second fairing portion is pivotally connected to the first fairing portion.

20. The motorcycle fairing of claim 14, wherein the second fairing portion is slidingly connected to the first fairing portion.
